(19) United States
(12) Patent Application Publication
(10) Pub. No.: US 2011/0302421 A1
(43) Pub. Date: Dec. 8, 2011

(54) Authentication Method And Apparatus Using One Time Pads

(76) Inventors: Keith Harrison, Monmouthshire (GB); Liqun Chen, Bristol (GB); William Munro, Stoke Gifford (GB)

(21) Appl. No.: 13/202,808

(22) PCT Filed: Jan. 20, 2010
(86) PCT No.: PCT/GB2010/050076

§ 371 Date: Aug. 23, 2011

(30) Foreign Application Priority Data
Feb. 24, 2009 (GB) 0903104.8

(51) Int. Cl. H04L 9/32

(52) U.S. Cl. 713/180

(57) ABSTRACT

An authentication method is provided between entities (10A; 10B) having matching one-time pads each with multiple OTP blocks. From the standpoint of a first one (10A) of the entities, the method involves sending (20S) a challenge that it has generated (20) by subjecting a first OTP block to a randomly-selected member of a first family of hashing functions. Each member of the first hashing-function family is associated with a respective member of a second family of hashing functions. On receiving back a response, the first entity (10A) tests (26) whether the response originates from the second entity (10B) by seeking a match between the response and a reference value generated (25) by subjecting a predetermined said OTP block to the member of the second hashing-function family that is associated with the member of the first hashing-function family used to generate the challenge.

### BACKGROUND

Quantum computing offers the possibility of almost unlimited computing power potentially sufficient to crack all conventional cryptographic techniques based on a handful of ‘hard’ problems such as the factoring of a number formed as the product of two large primes. There has therefore been increased interest recently in ways of carrying out security tasks, such as encryption and authentication, that do not depend on conventional cryptographic techniques.

As is well known, two entities that possess the same secret random data can provably achieve both unbreakable secure communication using the Vernam cipher, and discrimination between legitimate messages and false or altered ones (using, for example, Wegman-Carter authentication). In both cases, however, data used from the secret random data shared by the entities must not be re-used. The term “one-time pad” is therefore frequently used to refer to the secret random data shared by the entities and this term, or its acronym “OTP”, is used herein for secret random data shared by more than one entity. Although for absolute security the one-time pad data must be truly random, references to one-time pads (OTP) herein includes secret data that may not be truly random but is sufficiently random as to provide an acceptable degree of security for the purposes concerned.

### BRIEF DESCRIPTION OF THE DRAWINGS

Embodiments of the invention will now be described, by way of non-limiting example, with reference to the accompanying diagrammatic drawings, in which:

FIG. 1 is a diagram of a generalised form of OTP apparatus usable to implement embodiments of the invention;

FIG. 2 is a diagram of a first embodiment providing an example one-way authentication method; and

FIG. 3 is a diagram of a second embodiment providing an example two-way authentication method.

### DETAILED DESCRIPTION

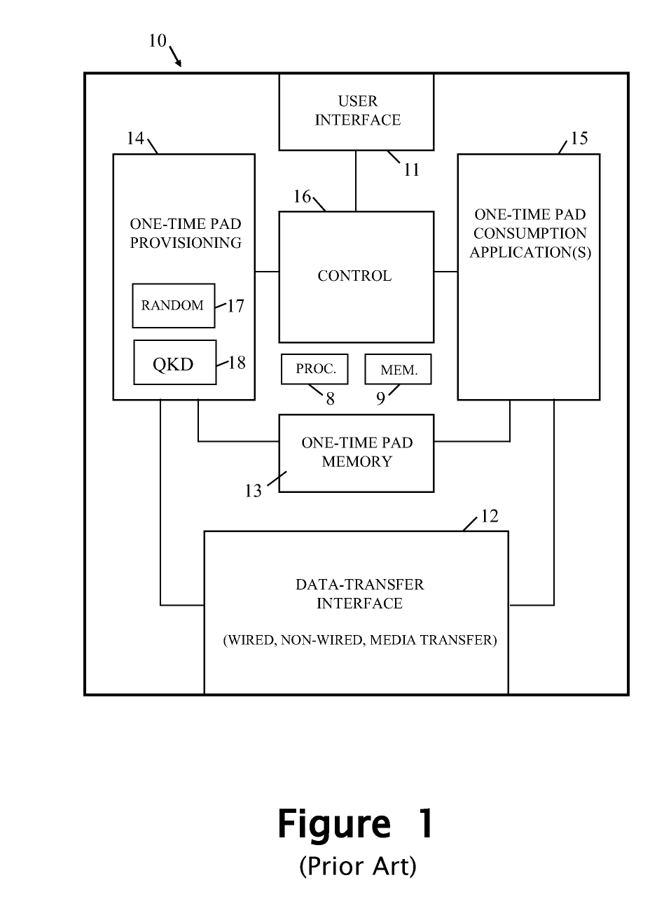

FIG. 1 shows, in generalized form, example OTP apparatus 10 for storing and using one-time pad data for various applications such as, for example, encryption and identification. The apparatus 10 can be portable in form (for example, constituted by hand-held devices such as mobile phones and PDAs); however, the apparatus 10 can be alternatively be of non-portable form such as a personal desktop computer.

In use, the OTP apparatus 10 is intended to communicate with other OTP apparatus having access to the same secret random data as the apparatus 10 in order to conduct an OTP interaction (that is, an interaction requiring use of the same OTP data by each apparatus). Such other OTP apparatus is hereinafter referred to as the “complementary OTP apparatus” with respect to the apparatus 10; this complementary apparatus can be of the same general form as the user OTP apparatus 10 or can be of a different form.

The OTP apparatus 10 comprises the following functional blocks:
a user interface block 11 for interfacing with a user;
a data-transfer interface 12 for transferring data to and/or from external entities by wired or non-wired means, or by media transfer;
a memory 13 for storing OTP data;
an OTP provisioning block 14 which, through interaction with an external entity, is arranged to provide new secret random data for initializing or replenishing the memory 13 with OTP data;
an OTP consumption block 15 for carrying out one or more security-related applications that consume OTP data stored in memory 13; and
a control block 16 for controlling and coordinating the operation of the other blocks in response to inputs received through the user interface 11 and the data-transfer interface 12.

Typically, the functional blocks 11 to 16 are implemented using a program-controlled processing arrangement configured to execute program code stored in a program memory, together with appropriate specialized sub-systems. Further details of each block are given below for the exemplary case where a processor-based system (including a main processor 8 and associated memory 9 holding program code) is used to carry out the data processing tasks of the apparatus 10, such tasks including, in particular, the control and coordination tasks of control block 16 and the running of the security applications embodying the OTP consumption block 15.

### User Interface 11

The user interface 11 typically comprises an LCD display and an input keypad but may also include audio input and/or output means. This interface is optional in the case of apparatus 10 intended for automatic operation.

### Data-Transfer Interface 12

The data-transfer interface 12 can comprise a non-wired interface such as a Bluetooth (Trademark) wireless interface or an IrDA infrared interface; however, a wired interface can alternatively or additionally be provided such as an USB interface (as used herein, the term “wired” is to be understood broadly to cover not only conductive wiring and optical fibres, but also any type of interface that requires electrical elements to be brought into physical contact). For circumstances where transit delay is not an issue, it is also possible to implement the data-transfer interface 12 as a removable storage medium (for example, a memory card) and related read/write arrangement.

### OTP Memory 13

The OTP memory 13 can be part of the general memory associated with the main processor 8 of apparatus 10 or can be formed by a separate memory. In either case, the OTP data is preferably secured against unauthorized access by one or more appropriate technologies. For example, the memory 13 can all be provided in a tamper-resistant hardware package. Alternatively, a protected storage mechanism can be used in which all but the root of a hierarchy (tree) of encrypted data objects is stored in ordinary memory, the root of the hierarchy being a storage root key which is stored in a tamper-resistant hardware package and is needed to decrypt any of the other data objects of the hierarchy. Furthermore, trusted platform techniques can be used to ensure that only authorized software can access the OTP data. It is also possible to use QRAM (Quantum RAM) technologies.

Where the apparatus 10 is designed such that OTP data is consumed immediately following its provisioning, the security requirements of memory 13 can be reduced (unless the apparatus 10 is designed to operate unattended).

### OTP Provisioning Block 14

With regard to the OTP provisioning block 14, the most secure way to share secret random data is to use a quantum key distribution (QKD) method such as described for example, in U.S. Pat. No. 5,515,438 and U.S. Pat. No. 5,999,285. In known QKD systems, randomly polarized photons are sent from a transmitting apparatus to a receiving apparatus either through a fiber-optic cable or free space. In the FIG. 1 example, the OTP provisioning block 14 is provided with a QKD subsystem 18 that can be either a QKD transmitter or a QKD receiver.

The OTP provisioning block 14 need not be built around a QKD subsystem and a number of alternative embodiments are possible. Thus, in one such alternative embodiment the OTP provisioning block 14 is simply arranged to store to the OTP memory 13, secret random data received via the data-transfer interface 12 from either:
(i) OTP apparatus seeking to share secret random data with the apparatus 10 either directly or via a trusted data store;
(ii) a trusted random data generator that has the role of generating secret random data and passing it (for example, over a wired connection or via a memory card) both to the apparatus 10 and to the OTP apparatus with which the apparatus 10 is wishing to interact using shared OTP data.

Rather than the secret random data being generated using a QKD subsystem or being received by the provisioning block 14 from an external source, the OTP provisioning block 14 can include a random data generator 17 for generating random data which is both used to provision the memory 13 with OTP data, and passed via the data-transfer interface 12 directly or indirectly (including via a trusted data store) to other OTP apparatus with which the apparatus 10 wishes to conduct OTP interactions. The random data generator is, for example, a quantum-based arrangement in which a half-silvered mirror is used to pass/deflect photons to detectors to correspondingly generate a “0”/“1” with a 50:50 chance; an alternative embodiment can be constructed based around overdriving a resistor or diode to take advantage of the electron noise to trigger a random event. Other techniques can be used for generating random data, particularly where a reduced level of security is acceptable—in such cases, some relaxation can be permitted on the randomness of the data allowing the use of pseudo random binary sequence generators which are well known in the art.

Where the secret random data is being received or being passed on via the data-transfer interface 12, then it must be done in a highly secure manner (for example, by using a wired interface to connect directly with OTP apparatus or a trusted data store). Encrypting the data being passed is general not going to provide an adequate solution because if the Vernam cipher is employed, at least as much OTP data would be consumed as newly provisioned, whereas standard cryptographic techniques are potentially vulnerable and would reduce the level of security obtained by using the OTP data.

The provisioning block 14 can simply append newly-obtained secret random data to the existing OTP data in memory 13 or can combine the new secret random data with the existing OTP data using a merge function, the merged data then replacing the previous contents of the memory 13. Preferably, the merge function is such that an eavesdropper who has somehow managed to obtain knowledge of the new secret random data, cannot derive any part of the merged data without also having knowledge of the pre-existing OTP data in the memory 13. A wide range of possible merge functions exist including functions for encrypting the new secret random data using the existing OTP data for the encrypting key, and random permutation functions (it will be appreciated that whatever merge function is used, it must be possible for the complementary OTP apparatus to select and use the same function on its copy of the new secret random data and its existing OTP data). Merging of the new secret random data and existing OTP data otherwise than by aggregation, can only be done if the apparatus 10 and the complementary OTP apparatus have the same existing OTP data which should therefore be confirmed between the two apparatus before the new secret random data and existing OTP data are subject to merging. In this respect, it will be appreciated that the OTP apparatus 10 and the complementary OTP apparatus may not have the same existing OTP data for a variety of reasons such as a failed communication between the two apparatus resulting in one of them consuming OTP data but not the other. Of course, it will frequently be possible for the OTP apparatus 10 and the complementary OTP apparatus to cooperate such that if either of them still has OTP data already discarded by the other, then that entity also discards the same data (one method of doing this is described later). However, it will not always be possible for the apparatus 10 and the complementary OTP apparatus to cooperate in this way, or even check whether they have the same existing OTP data, at the time that one or other of the device and apparatus is provided with new secret random data—for example, if the OTP apparatus is being replenished with new secret random data by communication with a trusted random data generator, it may well be that the trusted random data generator is not concurrently in communication with the complementary OTP apparatus, the new secret random data only being subsequently shared with the complementary OTP apparatus. In this type of situation, the new secret random data must be appended to the existing OTP data rather than being merged with it.

### OTP Consumption Block 15

The OTP consumption block 15 is arranged to carry out tasks (‘applications’) that require the use (‘consumption’) of OTP data from the memory 13; it is to be understood that, unless otherwise stated herein, whenever data is used from the OTP data held in memory 13, that data is discarded. As already indicated, the OTP consumption block 15 is preferably provided by arranging for the main processor of the apparatus 10 to execute OTP application programs; however, the consumption block 15 can additionally/alternatively comprise specialized hardware processing elements particularly where the OTP application to be executed involves complex processing or calls for high throughput.

A typical OTP consumption application is the evidencing that the apparatus 10 (or its owner/user) possesses a particular attribute. Thus, by way of simplified example, if a complementary OTP apparatus knows that it shares OTP data with OTP apparatus 10 having an identity “X”, then the apparatus 10 can identify itself to the complementary OTP apparatus by sending it a data block from the top of its one-time pad; the complementary apparatus then searches for this data block in the OTP pad it possesses and if a match is found, it knows that it is communicating with entity “X”. Since an OTP apparatus may hold multiple one-time pads, one for each other apparatus with which it wants to be able to have OTP interactions, the apparatus 10 preferably sends the other OTP apparatus an identifier of the one-time pad that the apparatus 10 is proposing to use.

As already noted, communication failures and other issues can result in different amounts of OTP data being held by the OTP apparatus 10 and the complementary OTP apparatus; more particularly, the data at the top of the one-time pad held by apparatus 10 can differ from the data at the top of the one-time pad held by the complementary OTP apparatus. This is referred to herein as “misalignment” of the one-time pads. It is therefore convenient for the OTP apparatus and the complementary OTP apparatus to each obtain or maintain a measure indicating how far it has progressed through its OTP data; this measure can also be thought of as a pointer or index to the head of the OTP pad and is therefore referred to below as the “head index”. Preferably, the head index is taken as the remaining size of the OTP data; although other measurements can be used for the head index (such as how much OTP data has been used), measuring the remaining size of the OTP data can be done at any time and so does not require any on-going maintenance. Whatever actual numeric value of the measure used for the head index, in the present specification the convention is used, when discussing head index values, that the nearer the top of the one-time pad is to the bottom of the pad, the “lower” is the value of the head index.

The head index is used to correct for misalignment of the one time pads held by the apparatus 10 and the complementary OTP apparatus as follows. At the start of any OTP interaction, the apparatus 10 and complementary OTP apparatus exchange their head indexes and one of them then discards data from the top of its one-time pad until its head index matches that received from the other—that is, until the one-time pads are back in alignment at the lowest of the exchanged head index values. When OTP data is used by the either apparatus in conducting the OTP transaction, the head index is sent along with the OTP interaction data (e.g. an OTP encrypted message) to enable the recipient to go directly to the correct OTP data in its one-time pad; this step can be omitted since although the one-time pads may have become misaligned by the time a message with OTP interaction data successfully passes in one direction or the other between the two apparatus, this misalignment is likely to be small and a trial-and-error process can be used to find the correct OTP data at the receiving end.

Authentication methods embodying the invention will now be described, these methods being implemented, by way of example, as OTP consumption applications carried out by the consumption blocks 15 of two OTP apparatus 10 of the FIG. 1 form (individually referenced as 10A, 10B below). The one-time pads of both OTP apparatus 10A and OTP apparatus 10B hold the same one-time pad data and no other entity knows this one-time pad data. It is assumed that the one-time pads are initially aligned (for example, as a result of an exchange of their head indexes as described above). The OTP data of each one-time pad can be thought of as comprising n-bit data blocks and, in particular, have the form:

a first data block X∥a second data block∥rest of the OTP data where ∥ represents concatenation.

For convenience, the following description is given in terms of operations carried out by entities “Alice” and “Bob” that respectively comprise the OTP apparatus 10A and the OTP apparatus 10B. Furthermore, the authentication carried out is based on the exclusiveness of the possession of the one-time pads and is therefore directly in respect of the OTP apparatus 10A and/or 10B. However, the authentication can be thought of in more general terms as being of the entities Alice and/or Bob; where these entities each also comprise respective parties that have exclusive control of the OTP apparatus 10A, 10B of the same entity, then the authentication is effectively of one or both of these parties. Indeed, the one-time pads may be directly held by such parties (for example, on respective memory cards) and only provided to the OTP apparatus, via the data-transfer interface 12, when required.

The authentication protocols now to be described utilizes multiple hashing functions; these hashing functions need not be cryptographically secure but can be any hashing functions that give a fairly uniform random distribution of output values for the range of inputs it is intended to handle (ideally, 2-universal hashing functions would be used but this is not necessary). The hashing functions are at least notionally organized into families where each family comprises multiple member hashing functions; the convention is used that for an i^{th} such family ƒᵢ, the j^{th} member is represented by ƒ_{i[j]}. While the member hashing functions of the same family can be totally unrelated functions, it is preferred that they are all instances of a family-generic parameterized hashing function having one or more parameters the values of which define the individual members. Indeed, the parameterized hashing function may have one or more further parameters which can be used to define a range of different family-generic hashing functions.

An example parameterized hashing function is SHA 256 (the well known Secure Hash Algorithm) which has eight parameters (these constitute the 8 Initial Vector (or IV) words); in this case, the generic hashing function of each family could be SHA 256 with its output truncated to 32 bits, each family being distinguished by a different respective value of a first parameter, and each member of the same family being distinguished by a different respective value of a second parameter.

In the case of a family-generic parameterized hashing function with one or more parameters that determine the specific family member, a random selection of the family member can be effected by using a respective nonce for the or each such parameter. Similarly, in the case of a parameterized hashing function having one or more parameters that are used to determine a specific family, a random selection of the family can be effected by using a respective nonce for the or each such parameter.

Conveniently, in the case of a family-generic parameterized hashing function with a member-selecting parameter Pₘ that determines the specific family member, for the j^{th} family member the value of this parameter Pₘ is j. By way of example, consider a family-generic parameterized hashing function, for an i^{th} family, of the form:

ƒ_{i[j]}=#(D∥Pₘ) (1)

where # is a known hash function, D is the subject data to be hashed, Pₘ is a parameter the value of which determines the family member, and ∥ represents concatenation. Then with Pₘ equal to j for the j^{th} member of the family:

ƒ_{i[j]}=#(D∥j) (2)

Random selection of a member from the family can be effected by generating a nonce Nₘ and using it for the parameter Pₘ, that is:

ƒ_{i[Nm]=#(}D∥Nₘ) (3)

Similarly, where different families of hashing function are specified by different values of a family-selecting parameter P_{f} of a parameterized hashing function, then conveniently, for the i^{th} such family, the parameter P_{f} has a value i. Extending the foregoing example by adding a further, family-specific, parameter P_{f}:

ƒ_{i[j]}=#(D∥P_{f}∥Pₘ) (4)

then with the value of P_{f} equal to i for the i^{th} family (and Pₘ equal to j for the j^{th} member):

ƒ_{i[j]}=#(D∥i∥j) (5)

Random selection of a family can be effected by generating a nonce N_{f} and using it for the parameter P_{f}, that is:

ƒ_{Nf[j]}=#(D∥N_{f}∥Pₘ) (6)

A randomly chosen member of a randomly chosen family would then be:

ƒ_{Nf[Nm]}=#(D∥Nₘ∥N_{f}) (7)

### First Embodiment

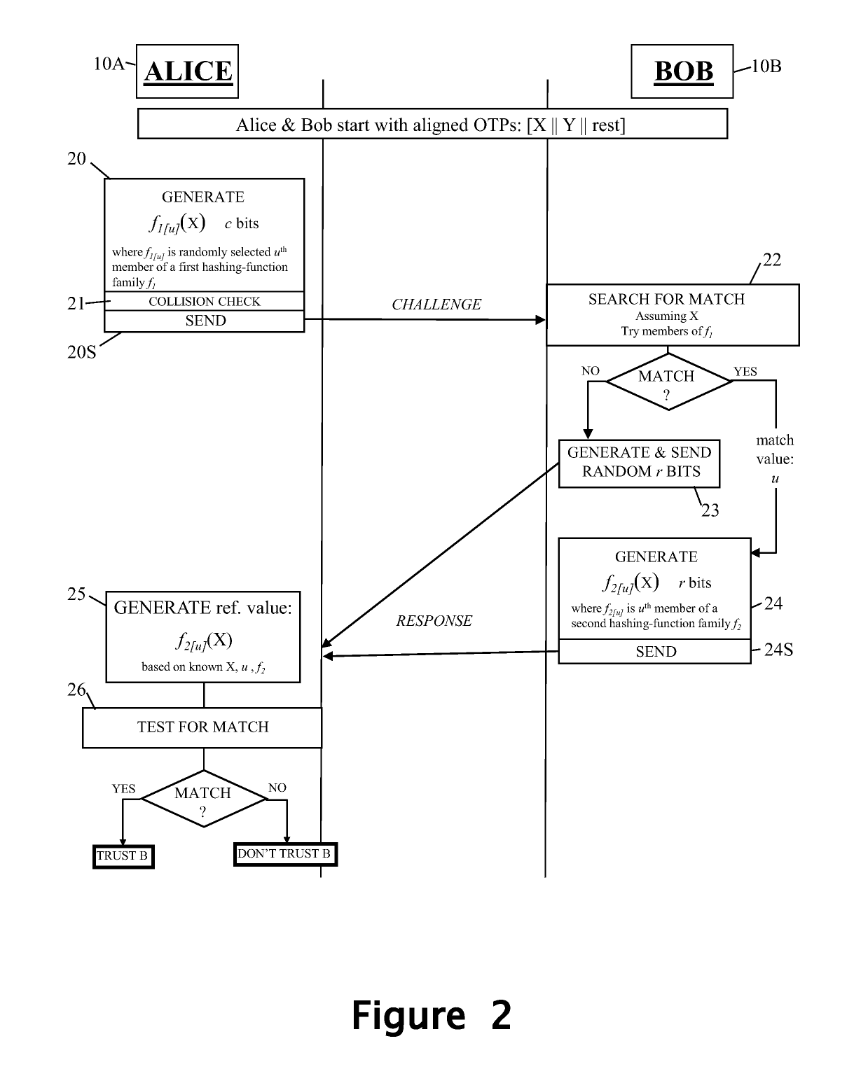

### FIG. 2

FIG. 2 shows a first embodiment of the invention, this being a one-way authentication method in which one entity authenticates the other but not vice verse. In this example, Alice authenticates Bob by issuing a challenge (CHALLENGE) based on Alice's one-time pad, and, on receiving back a response (RESPONSE), checking that the latter exhibits knowledge of the same one-time pad.

Alice and Bob both have knowledge of a first family of hashing functions ƒ₁ arranged to generate a c-bit hash value, and a second family of hashing functions ƒ₂ arranged to generate an r-bit hash value. Each member of the first hashing-function family is associated with a respective member of the second hashing-function family—by way of example, this can be expressed in general terms as the j^{th} members of both families being associated. Thus where the first family of hashing functions comprises p members, the second family will also comprise p members.

The FIG. 2 authentication method comprises steps 20 to 26 and proceeds as set out below.
Step 20 Alice generates a c-bit challenge (CHALLENGE) by randomly selecting a member of the first family of hashing functions (here designated the u^{th} member) and applying it to the first OTP block X. Alice sends the challenge to Bob (it will be appreciated that the challenge will generally be encapsulated within a longer message). The values of n (OTP block size), p (number of members in the first hashing-function family) and c are such that (n+log₂ p>>c); in other words, the number of bits that an eavesdropper can discover (the challenge bits) is very much less than the equivalent bit size of the unknown data (the value of X and the identity of the hashing function selected from the first family).
Step 21A consequence of the restricted size of c is that it may be possible to produce the same challenge value by subjecting the OTP block X to a different member of the first hashing-function family to that used to generate the challenge. In order to eliminate such possible ambiguity, Alice carries out a conflict check 21 before sending the challenge. This conflict check involves comparing the generated challenge value to the values produced by subjecting X to all member functions of the first family other than that actually used to generate the challenge (the u^{th} member). If a match is found (indicating a conflict), step 20 is re-initiated.
Step 20S If no match is found in step 21, the challenge is sent.
Step 220n receiving the challenge (CHALLENGE), Bob seeks a match between the value of the challenge and any reference value in the set of such values that can be generated by subjecting its first OTP block X to the members of the first family of hashing functions.
Step 23 If no match is found (which would be the case if the first block of Bob's one-time pad differed from that of Alice's one-time pad), Bob generates and sends a random r-bit response (RESPONSE) to Alice.
Step 24 If a match is found (which should be the case in the present example as Alice and Bob have matching one-time pads), then Bob will know that the u^{th} member of the first hashing-function family (that is, ƒ_{i[u]}) was used to generate the challenge. Bob proceeds by using the associated hashing function of the second family (that is, ƒ_{2[u]}) to generate an r-bit response (RESPONSE); in particular, Bob applies ƒ_{2[u]} to a predetermined OTP block (in this example, the first block X, though a different block could be used).
Step 24S Bob sends the response to Alice.
   It will be appreciated that, whether generated in step 23 or 24, the response will generally be encapsulated within a longer message for sending to Alice. The value of r is such that (n+log₂ p>>r); in other words, the number of bits that an eavesdropper can discover (the response bits) is very much less than the equivalent bit size of the unknown data (the value of X and the identity of the second-family hashing function used to generate the response).
Step 25 Alice generates a reference value by subjecting the predetermined OTP block that Alice expects Bob to use in generating the response (in this example, X) to the u^{th} member of the second hashing-function family (that is, the second-family member associated with the first-family member used to generate the challenge). Alice can carry out step 25 at substantially the same time as step 20 and store the resultant reference value pending the receipt of Bob's response, or Alice can wait until the Bob's response is received before generating the reference value (in this latter case, Alice must store the value of u in step 20).
Step 26 After receiving the response (RESPONSE), Alice tests whether the response originates from Bob by seeking a match between the response and the reference value generated in step 25. A match will only be found if the response has been generated by an entity with the same one-time pad as Alice (that is, by Bob) since Bob is the only other entity apart from Alice that can have recovered the identity of the u^{th} hashing function of the first family used to generate the challenge, or have used the predetermined OTP block (in this example, block X) in the response. Thus, if a match is found, Alice is satisfied that she is talking to Bob. If no match is found, Alice does not trust that the entity she is talking to, is Bob. It is possible, of course, that no match is found even where the sender of the response is indeed Bob—this would be the case where Bob was unable to find a match in step 22 and generated its response as a random r bits.

Overall, an eavesdropper can only capture c+r bits at most and n andp are such that:

(n+log₂ p)>>(c+r)

whereby there is no realistic prospect of an eavesdropper discovering anything useful. Furthermore, an eavesdropper is even unable to tell from the response whether Bob has found a match in step 22.

### Second Embodiment

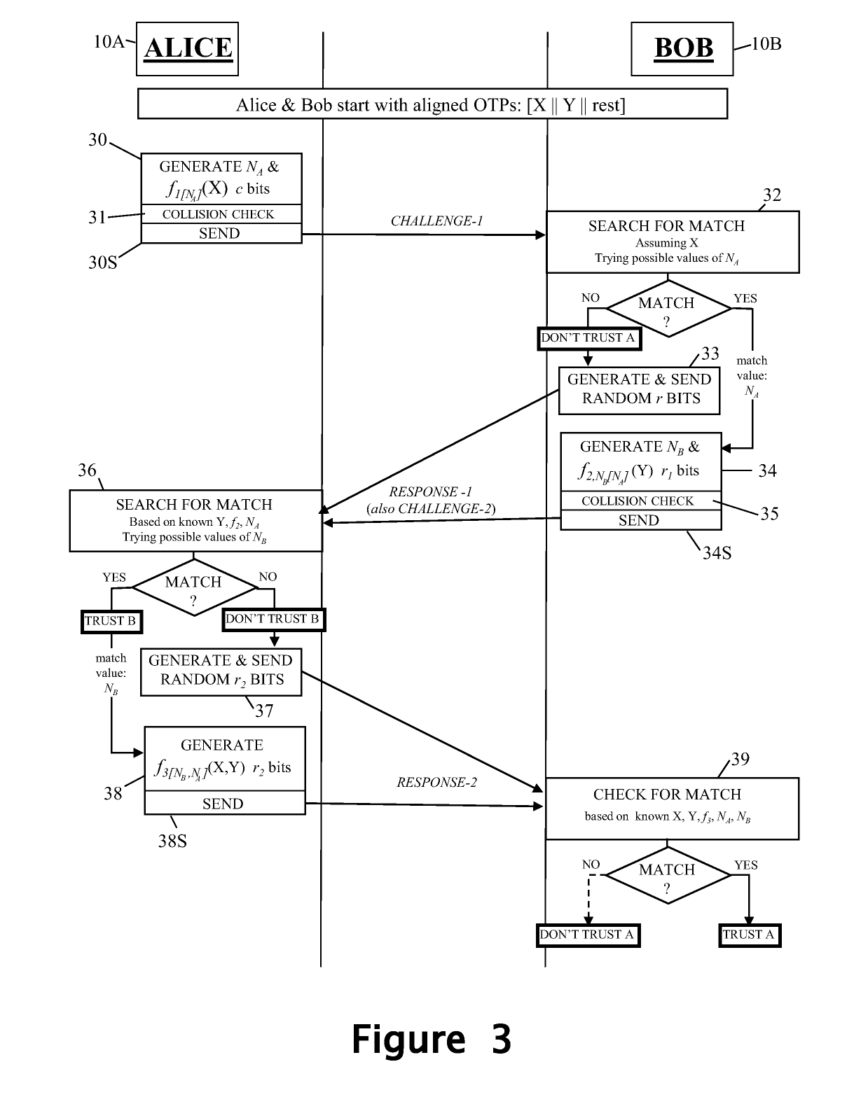

### FIG. 3

FIG. 3 shows a second embodiment of the invention, this being a two-way authentication method in which two parties (again, Alice 10A and Bob 10B) authenticate each other. In effect, it is an efficient merging of two one-way authentication Challenge—Response cycles each similar to that described above with reference to FIG. 2. Thus, Alice authenticates Bob by issuing a first challenge (CHALLENGE-1) and checking the received response (RESPONSE-1), and Bob authenticates Alice by issuing a second challenge (CHALLENGE-2) and checking the received response (RESPONSE-2); however, for efficiency, Bob's response (RESPONSE-1) is merged with Bob's challenge (CHALLENGE-2), resulting in a three-message two-way authentication protocol.

Alice and Bob both have knowledge of the following families of hashing functions:
A first hashing-function family ƒ₁ comprising p members each arranged to generate a c-bit hash value. This first family ƒᵢ is preferably based on a first parameterized hashing function with a member-selecting parameter P₁ₘ the value of which corresponds to the member identity, that is, for the j^{th} member ƒ_{1[j]} the value of the member-selecting parameter P₁ₘ is j. The first parameterized hashing function can, for example, have the form given in equation (2) above, that is: ƒ_{1[j]}=#(D∥j).
A plurality q of second hashing-function families ƒ₂ each comprising p members arranged to generate an r₁-bit hash value. These q second families ƒ₂ are preferably based on a second parameterized hashing function ƒ₂ with both:
   a family-selecting parameter P_{2f} for selecting the second family, with the value of the family-selecting parameter corresponding to the second family identity, that is, for the i^{th} second family ƒ_{2,i} the value of the family-selecting parameter P_{2f} is i; and
   a member-selecting parameter P₂ₘ the value of which corresponds to the member identity, that is, for the j^{th} member of the i^{th} second family
   ƒ_{2,i[j]} the value of the member-selecting parameter P₂ₘ is j.
Each member of the first hashing-function family ƒ₁ is associated with a respective member of each of the q second hashing-function families ƒ_{2,i}—in the present example, the j^{th} member of the first family is associated with the j^{th} member of each second family. The second parameterized hashing function can, for example, have the form given in equation (4) above, that is: ƒ_{2,i[j]}=#(D∥P_{2f}∥P₂ₘ)
A third hashing-function family ƒ₃, comprising (q)×(p) members each arranged to generate an r₂-bit hash value. This third family ƒ₃ is preferably based on a third parameterized hashing function that has both:
   a first member-selecting parameter P₃ₘ₁ with at least q possible values, each associated with a respective one of the second families ƒ₂, and
   a second member-selecting parameter P₃ₘ₂ with at least p possible values, each associated with a respective member of every second family.
As a result, there is a respective member of the third family ƒ₃ for every member of every second family ƒ_{2,i}. The third parameterized hashing function can, for example, have the general form given in equation (4) above but with a second member-selecting parameter instead of the family-selecting parameter, that is: ƒ_{3[j]}=#(D∥P₃ₘ₁∥P₃ₘ₂).

The FIG. 3 authentication method comprises steps 30 to 39 and proceeds as set out below.
Step 30 Alice generates a c-bit challenge (CHALLENGE-1) by randomly selecting a member of the first family of hashing functions and applying it to the first OTP block X. In this example, the random selection of the first family member is effected by generating a nonce N_{A} and using it for the member-selecting parameter P₁ₘ, the selected function then being ƒ_{1[N}_{_{A}}_{]}. Alice sends the challenge to Bob (CHALLENGE-1). As for the first embodiment, the values of n (OTP block size), p (number of members in the first hashing-function family) and c are such that (n+log₂ p>>c).
Step 31 Alice carries out a conflict check 31 before sending the challenge. This conflict check involves comparing the generated challenge value to the values produced by subjecting X to all member functions of the first family other than that actually used to generate the challenge (the N_{A}^{th} member). If a match is found (indicating a conflict), step 30 is re-initiated.
Step 30S If no match is found in step 30, the challenge is sent.
Step 320n receiving the challenge (CHALLENGE-1), Bob seeks a match between the value of the challenge and any reference value in the set of such values that can be generated by subjecting its first OTP block X to the members of the first family of hashing functions.
Step 33 If no match is found (which would be the case if the first block of Bob's one-time pad differed from that of Alice's one-time pad), Bob generates and sends a random r₁-bit response (RESPONSE-1), to Alice.
Step 34 If a match is found (which should be the case in the present example as Alice and Bob having matching one-time pads), then Bob will know that the N_{A}^{th} member of the first hashing-function family (that is, ƒ_{i[N}_{_{A}}_{]}) was used to generate the challenge. Bob proceeds by randomly choosing one of the second hashing function families and using the N_{A}^{th} member of that family to generate an r₁-bit value. In this example, the random selection of the second family is effected by generating a nonce N_{B} and using it for the family-selecting parameter P_{2f}, the selected second family then being ƒ_{2,N}_{_{B}}. The N_{A}^{th} member of this family ƒ_{2,N}_{_{B}}_{[N}_{_{A}}_{]} is obtained by setting the member-selecting parameter P₂ₘ to the value N_{A}. This function ƒ_{2,N}_{_{B}}_{[N}_{_{A}}_{]} is applied to a predetermined OTP block (in this example, the second block Y) to generate the r₁-bit value to serve both as a response (RESPONSE-1) to Alice's challenge and as Bob's challenge (CHALLENGE-2) to Alice. It can be seen that the r₁-bit value is akin to the response generated in the FIG. 2 one-way authentication method as it is based on a knowledge of which member of the first hashing-function family was used to generate Alice's challenge. It can also be seen that the r₁-bit value is akin to the challenge generated by Alice in the FIG. 2 one-way authentication method as it is based both on a random element in the selection of the hashing function used and employs a new OTP block.
Step 35 As with the generation of Alice's challenge (CHALLENGE-1), Bob carries out a conflict check 35 before sending the r₁-bit value that is Bob's challenge (CHALLENGE-2). This conflict check involves comparing the generated r₁-bit value to the values produced by subjecting OTP block Y to the N_{A}^{th} member function of every second family other than that actually used to generate r₁-bit value (the second family ƒ_{2,N}_{_{B}}). If a match is found (indicating a conflict), step 34 is re-initiated.
Step 34S If no match is found in step 35, the r₁-bit value generated in step 34 is sent as (RESPONSE-1)/(CHALLENGE-2).
   The bit size r₁ of the response sent in step 33 or 34S is such that (n+log₂ p+log₂ q>>r₁); in other words, the number of bits that an eavesdropper can discover from the bits of the RESPONSE-1/CHALLENGE-2 is very much less than the equivalent bit size of the unknown data (the value of Y and the identity of the second-family hashing function used to generate the response).
Step 36 Alice receives the r₁-bit RESPONSE-1/CHALLENGE-2 from Bob. Based on Alice's knowledge of N_{A} (stored during step 30), the parameterised hashing function ƒ₂, and the predetermined OTP block (Y in this example) that Alice expects Bob to use in generating RESPONSE-1/CHALLENGE-2, Alice tests whether the RESPONSE-1/CHALLENGE-2 originates from Bob by seeking a match with any reference value in the set of such values that can be generated by subjecting the predetermined OTP block, for each of the q second-hashing-function families, to the N_{A}^{th} family member (that is, the family member associated with the first-hashing-function family member used to generate CHALLENGE-1). In the present example, this means moving through the possible values for the second-family-selecting parameter P_{2f} until either a match is found or all values have been tried.
Step 37 If no match is found in step 36, Alice does not trust that the entity she is talking to is Bob and Alice generates and sends a random r₂-bit response (RESPONSE-2) to Bob. (It is possible, of course, that no match is found even where the sender of the response is indeed Bob—this would be the case where Bob was unable to find a match in step 32 and generated its response as a random r₁ bits).
Step 38 If a match is found in step 36 (which should be the case in the present example as Alice and Bob having matching one-time pads), then Alice is satisfied that she is talking to Bob. Alice will also know that the N_{B}^{th} second hashing-function family (that is, ƒ_{2,N}_{_{B}}) was used to generate the challenge. Alice proceeds to generate an r₂-bit response (RESPONSE-2) by subjecting a predetermined combination of the first OTP block X and the OTP block used by Bob (block Y in this example) to the member of the third hashing-function family associated with the second hashing-function family, and the member of that family, used by Bob to generate RESPONSE-1/CHALLENGE-2. In the present example, the appropriate hashing function is obtained by setting the first and second member-selecting parameters P₃ₘ₁ and P₃ₘ₂ of the third parameterised hashing function ƒ₃ to the values N_{B} and N_{A} respectively.
Step 38S Alice sends the r₂-bit response (RESPONSE-2) generated in step 38 to Bob.
   The bit size r₂ of the response sent in step 37 or 38S is such that (2n+log₂ p+log₂ q>>r₂); in other words, the number of bits that an eavesdropper can discover from the bits of RESPONSE-2 is very much less than the equivalent bit size of the unknown data (the values of X and Y, and the identity of the third-family hashing function used to generate RESPONSE-2).
Step 390n receiving RESPONSE-2, Bob checks for a match with a reference value it has generated by subjecting the first and predetermined OTP blocks (in this example, blocks X and Y) to the member hashing function of a third family given by using the values N_{B} and N_{A} respectively for the first and second member-selecting parameters P₃ₘ₁ and P₃ₘ₂ (that is, the third-hashing-function family member associated with the second-hashing-function family, and the member of that family, used to generate RESPONSE-1/CHALLENGE-2). If a match is found, Bob trusts that he is talking to Alice whereas if there is no match, Bob does not trust he is talking to Alice.

Overall, an eavesdropper can only capture (c+r₁+r₂) bits at most and n, p and q are such that:

(2n+log₂ p+log₂ q)>>(c+r₁+r₂)

whereby there is no realistic prospect of an eavesdropper discovering anything useful. Furthermore, an eavesdropper is even unable to tell from the response whether matches have been found in steps 32 and 36. Preferably all challenges and responses are the same size.

By way of example:

n=64;

p,q=256(log₂ p,log₂ q=8);

c,r₁,r₂=32.

In one specific example of the FIG. 3 embodiment:

the CHALLENGE-1 is generated by Alice as:

#(X∥N_{A})

the RESPONSE-1/CHALLENGE-2 is generated by Bob as:

#(Y∥N_{A}∥N_{B})

the RESPONSE-2 is generated by Alice as:

#(X∥Y∥N_{B}∥N_{A}).

where # is SHA 256 truncated to 32 bits.

With regard to the above-described embodiments, it may be noted that the amount of unknown information introduced by Alice's random choice of the member of the first hashing-function in step 20/30 is, in fact, less than p (number of members) by the number of conflicts found in step 21/31. Similarly, the amount of unknown information introduced by Bob's random choice of second hashing-function family in step 34 is, in fact, less than q (number of second families) by the number of conflicts found in step 35. However, provided log₂ p/log₂ q is kept sufficiently below the size of the challenge c/response r₁ (in other words, c>>log₂ p/r₁>>log₂ q), the number of conflicts will be very low and can be ignored for practical purposes; in any event, a good idea of the number of conflicts likely to occur can be determined through simulation and appropriate adjustment of p and q can be made in the above inequalities.

Many variants are possible to the above described embodiments of the invention. For example, although the conflict checks carried out in step 21, 31 and 35 are preferred, they can be omitted where a slightly reduced degree of certainty in the authentication effected is acceptable.

Furthermore, although embodiments of the invention have been described in relation to OTP apparatus that incorporates, in a self-contained form, OTP storage, provisioning, and consumption, it is to be understood that the apparatus could generally be replaced by a distributed arrangement of its functional blocks. Indeed, any form of OTP apparatus can be used provided it is capable of performing the steps of the authentication-method embodiment to be implemented.

1. Apparatus (10) for enabling a first entity (10A) associated with the apparatus to authenticate a second entity (10B) where both entities have matching one-time pads each with multiple n-bit OTP blocks; the apparatus (10) comprising a processing arrangement (15) operative to:
generate (20; 30) a c-bit challenge by subjecting a first OTP block to a randomly-selected member of a first family of hashing functions comprising p members, each member of the first hashing-function family being associated with a respective member of a second family of hashing functions;
send (29S; 30) the challenge and receive back an r-bit response, the values of n, p, c and r being such that (n+log₂ p)>>(c+r); and
test (26; 36) whether the response originates from the second entity (10B) by seeking a match between the response and a reference value generated by subjecting a predetermined said OTP block to the member of the second hashing-function family that is associated with the member of the first hashing-function family used to generate the challenge.

2. Apparatus according to claim 1, wherein the processing arrangement (15) is further operative to check (21; 31), before the challenge is sent, that its value is distinct from all values that can be generated by applying the members of the first family, other than that used to generate the challenge, to the first OTP block; and, where a conflict is found, to re-initiate generation of the challenge.

3. Apparatus according to claim 1, wherein:
each member of the first hashing-function family is associated with a respective member of each of q second families of hashing functions; and
the processing arrangement (15) is operative to test (36) whether the response originates from the second entity (10B) by seeking a match between the response and any reference value in the set of such values that can be generated by subjecting the predetermined OTP block, for each of the q second-hashing-function families, to the family member that is associated with the first-hashing-function family member used to generate the challenge.

4. Apparatus according to claim 3, further comprising the processing arrangement (15), in order to authenticate the first entity (10A), is further operative to reply to the response by sending (38S) a reply which it generates (38) by subjecting a predetermined combination of said first and predetermined OTP blocks to a hashing function that is a member of a third family of hashing functions, the third-hashing-function family member used being dependent on both the second-hashing-function family, and the member of that family, used to generate the reference value found to match the response.

5. Apparatus according to claim 1, wherein c>>log₂ p.

6. Apparatus (10) for enabling a second entity (10B) associated with the apparatus to authenticate itself to a first entity (10A) where both entities have matching one-time pads each with multiple n-bit OTP blocks; the apparatus comprising a processing arrangement (15) operative to:
receive a c-bit challenge and seek (22; 32) a match between the challenge and any reference value in the set of such values that can be generated by subjecting a first OTP block to the members of a first family of hashing functions comprising p members;
generate (24; 34), where a match to the challenge is found, an r-bit response by subjecting a predetermined OTP block to a member of a second family of hashing functions, each member of the first hashing-function family being associated with a respective member of the second family of hashing functions, and the member of the second hashing-function family used to generate the response being that associated with the member of the first-hashing function family giving rise to the reference value matching the challenge; and
send back (24S; 34S) the response, the values of n, p, c and r being such that (n+log₂ p)>>(c+r).

7. Apparatus according to claim 6, wherein:
each member of the first hashing-function family is associated with a respective member of each of q second families of hashing functions; and
the processing arrangement (15) is operative to generate (34) the response by randomly selecting one of the q second families of hashing function, and subjecting the predetermined OTP block to the member of the selected second family, that is associated with the first-hashing-function family member giving rise to the reference value matching the challenge.

8. Apparatus according to claim 7, wherein the processing arrangement (15) is further operative to check (35), before the response is sent, that its value is distinct from all values that can be generated by subjecting the predetermined OTP block to the member of each non-selected second hashing-function family, that is associated with the first-hashing-function family member giving rise to the reference value matching the challenge; and, where a conflict is found, to re-initiate generation of the response.

9. Apparatus according to claim 8, wherein the processing arrangement (15) is further operative to receive a reply to the response, and test (19) whether the reply originates from the first entity (10A) by seeking a match between the reply and a reference value generated by subjecting a predetermined combination of said first and predetermined OTP blocks to a hashing function that is a member of a third family of hashing functions, the third-hashing-function family member used being dependent on both the second-hashing-function family, and the member of that family, used to generate the response.

10. Apparatus according to claim 6, wherein r>>log₂ q.

11. An authentication method by which a first entity (10A) can authenticate a second entity (10A) where both entities have matching one-time pads each with multiple n-bit OTP blocks; the method comprising:
first computing apparatus (10A) of the first entity:
generating (20) a c-bit challenge by subjecting a first OTP block of the one-time pad of the first entity (10A) to a randomly-selected member of a first family of hashing functions comprising p members, each member of the first hashing-function family being associated with a respective member of a second family of hashing functions;
sending (20S; 30S) the challenge to the second entity (10B), the values of n, p and c being such that (n+log₂ p)>>c;
second computing apparatus (10B) of second entity:
receiving the challenge and seeking (22; 32) a match between the challenge and any reference value in the set of such values that can be generated by subjecting a first OTP block of the one-time pad of the second entity to the members of the first family of hashing functions;
where a match to the challenge is found, generating (24; 34) an r-bit response by subjecting a second OTP block of the one-time pad of the second entity to the member of the second family of hashing functions, that is associated with the member of the first hashing-function family giving rise to the reference value matching the challenge;
sending back (24S; 34S) the response, the values of n, p, c and r being such that (n+log₂ p)>>r, and
the first computing apparatus (10A):
receiving the response and testing (26; 36) whether the response originates from the second entity (10B) by seeking a match between the response and a reference value generated by subjecting a second OTP block of the one-time pad of the first entity, to the member of the second hashing-function family that is associated with the member of the first hashing-function family used to generate the challenge.

12. A method according to claim 11, wherein:
each member of the first hashing-function family is associated with a respective member of each of q second families of hashing functions;
the generation (24; 34) of the response by the second computing apparatus (10B) involves randomly selecting one of the q second families of hashing function, and subjecting the second OTP block to the member of the selected second family, that is associated with the member of the first-hashing-function family giving rise to the reference value matching the challenge; and
the testing (26; 36) by the first computing apparatus (10A) whether the response originates from the second entity (10B) involves seeking a match between the response and any reference value in the set of such values that can be generated by subjecting the second OTP block, for each of the q second-hashing-function families, to the family member that is associated with the member of the first hashing-function family used to generate the challenge.

13. A method according to claim 12, wherein the first computing apparatus (10A), in order to authenticate the first entity (10A) to the second entity (10B), replies to the response by sending (38S) a reply generated (38) by subjecting a predetermined combination of the first and second OTP blocks to a hashing function that is a member of a third family of hashing functions, the third-hashing-function family member used being dependent on both the second-hashing-function family, and the member of that family, used to generate the reference value found to match the response.

14. A method according to claim 13, further comprising the second computing apparatus (10B) receiving the reply, and testing (39) whether the reply originates from the first entity (10A) by seeking a match between the reply and a reference value generated by subjecting a predetermined combination of the first and second OTP blocks to a member of the third family of hashing functions, the member of the third hashing-function family used being dependent on both the second hashing-function family, and the member of that family, used to generate the response.

15. A method according to claim 14, wherein:
the challenge is generated (30) by the first computing apparatus (10A) as:
#(X∥N_{A})
where # is a predetermined hash function, X is the first OTP block, and N_{A} is a nonce generated by the first entity;
the reference values against which the challenge is checked (32) by the second computing apparatus (10B), are generated as:
#(X∥V)
where V is a variable;
the response is generated (34) by the second computing apparatus (10B) as:
#(Y∥N_{A}∥N_{B})
where Y is the second OTP block, N_{A} is the value of V giving rise to the reference value matching the challenge, and N_{B} is a nonce generated by the second entity (10A);
the reference values against which the response is checked (36) by the first computing apparatus (10A), are generated as:
#(Y∥N_{A}∥W)
where W is a variable;
the reply is generated (38) by the first computing apparatus (10A) as:
#(X∥Y∥N_{B}∥N_{A}).
where N_{B} is the value of W giving rise to the reference value matching the response; and
the reference value against which the reply is checked (39) by the second computing apparatus (10B) is generated as:
#(X∥Y∥N_{B}∥N_{A}).
